(19) United States
(12) Patent Application Publication
(10) Pub. No.: US 2020/0178731 A1
(43) Pub. Date: Jun. 11, 2020

(54) HEAT GENERATING DEVICE OF TOASTER

(71) Applicant: DONGGUAN CITY JINYI ELECTRONIC TECHNOLOGY CO., LTD., Dongguan City (CN)

(72) Inventor: Heping Zheng, Dongguan City (CN)

(21) Appl. No.: 16/214,157

(22) Filed: Dec. 10, 2018

(51) Int. Cl. A47J 37/08; H05B 3/14

(52) U.S. Cl. CPC A47J 37/08; H05B 3/141

(57) ABSTRACT

A heat generating device of a toaster includes a frame, two side electric heating plates mounted at two sides of the frame, and a middle electric heating plate disposed between the two side electric heating plates. A baking chamber is formed between every adjacent two of the electric heating plates for baking sliced bread. Each of the electric heating plates includes a substrate and a heat-generating metal film. A surface of the substrate of each of the two side electric heating plates, facing the baking chamber, is bonded with the heat-generating metal film. Front and back surfaces of the substrate of the middle heating plate are bonded with the heat-generating metal film.

### BACKGROUND OF THE INVENTION

### 1. Field of the Invention

The present invention relates to a toaster, and more particularly to a heat generating device of a toaster.

### 2. Description of the Prior Art

The electric heating plate of a conventional toaster uses a mica plate as a substrate. A heating wire is wound on the mica plate. In order to fix the heating wire or prevent the heating wire from being thermally expanded, the mica plate is provided with a mica press bar to press the heating wire. The mica plate and the mica press bar are fixed together.

For example, as disclosed in Chinese Utility Model No. CN 203138129 U, the left side and the right side of the toaster are provided with electric heating plates, and a plurality of heating wires are wound on the electric heating plates. When winding the heating wires, they are wound from the front to the back of the electric heating plate, and then pass through the back to the front. This way is repeated. When electrified, the front and the back of this electric heating plate generate heat. However, in fact, only the heat generated from the side facing the baking chamber can be effectively utilized, and the heat generated from the other side facing away from the baking chamber is basically wasted, resulting in great loss of power consumption.

In view of this, a modified electric heating plate of a toaster is developed on the market, as shown in FIG. 1 and FIG. 2. Most of the heating wire 1 is wound around the front 3 of the electric heating plate 2, and only a small portion of the heating wire 1 is exposed on the back 4 of the electric heating plate 2. When the heating wire is wound, it is wound from the front of the electric heating plate to the back, and is bent from the first groove 5 and then returned from the second groove 6 at the same side to the front of the electric heating plate. The winding structure of the back of the electric heating plate is shown in FIG. 2. This winding manner can effectively reduce unnecessary power loss, but a small part of the power is still wasted.

### SUMMARY OF THE INVENTION

In view of the shortcomings of the prior art, the primary object of the present invention is to provide a heat generating device of a toaster, having the advantages of a clean and beautiful appearance, uniform heat generation, energy saving, stable performance and easy processing and molding, thereby overcoming the deficiencies of the prior art.

In order to achieve the above object, the present invention adopts the following technical solutions:

A heat generating device of a toaster comprises a frame, two side electric heating plates mounted at two sides of the frame, and a middle electric heating plate disposed between the two side electric heating plates. A baking chamber is formed between every adjacent two of the electric heating plates for baking sliced bread. Each of the electric heating plates includes a substrate and a heat-generating metal film. A surface of the substrate of each of the two side electric heating plates, facing the baking chamber, is bonded with the heat-generating metal film. Front and back surfaces of the substrate of the middle heating plate are bonded with the heat-generating metal film.

Compared with the prior art, the present invention has obvious advantages and beneficial effects. Specifically, it can be known from the above technical solutions that the electric heating plate is formed by attaching and fixing the heat-generating metal film to the substrate, so that the circuit pattern of the heat-generating metal film may be various, and the spacing and thickness of the heat-generating metal film can be controlled freely. The heat generating device has the advantages of a clean and beautiful appearance, uniform heat generation, stable performance and easy processing and molding.

Particularly, both surfaces of the middle electric heating plate are provided with the heat-generating metal film As to the two side electric heating plates, only the surface facing the baking chamber is provided with the heat-generating metal film, and the surface facing away from the baking chamber doesn't have the heat-generating metal film This can save energy to the maximum and improve the baking efficiency of the sliced and reduce the power loss.

### BRIEF DESCRIPTION OF THE DRAWINGS

FIG. 1 is a front schematic view of a conventional electric heating plate;

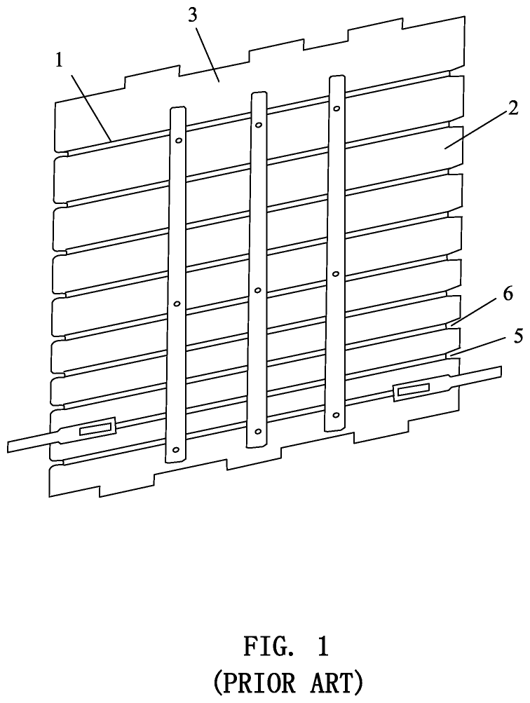

FIG. 2 is a rear schematic view of the conventional electric heating plate;

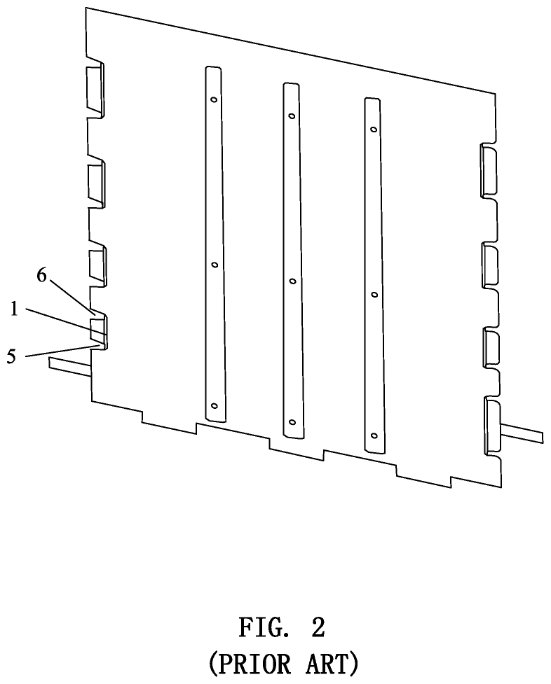

FIG. 3 is a perspective view of the heat generating device according to a preferred embodiment of the present invention;

FIG. 4 is another perspective view of the heat generating device according to the preferred embodiment of the present invention;

FIG. 5 is a rear view of the left electric heating plate according to the preferred embodiment of the present invention;

FIG. 6 is a front view of the left electric heating plate according to the preferred embodiment of the present invention;

FIG. 7 is a left view of the left electric heating plate according to the preferred embodiment of the present invention;

FIG. 8 is a rear view of the middle electric heating plate according to the preferred embodiment of the present invention;

FIG. 9 is a front view of the middle electric heating plate according to the preferred embodiment of the present invention;

FIG. 10 is a left view of the middle electric heating plate according to the preferred embodiment of the present invention;

FIG. 11 is a front view of the right electric heating plate according to the preferred embodiment of the present invention;

FIG. 12 is a rear view of the right electric heating plate according to the preferred embodiment of the present invention; and

FIG. 13 is a left view of the right electric heating plate according to the preferred embodiment of the present invention.

### DETAILED DESCRIPTION OF THE PREFERRED EMBODIMENTS

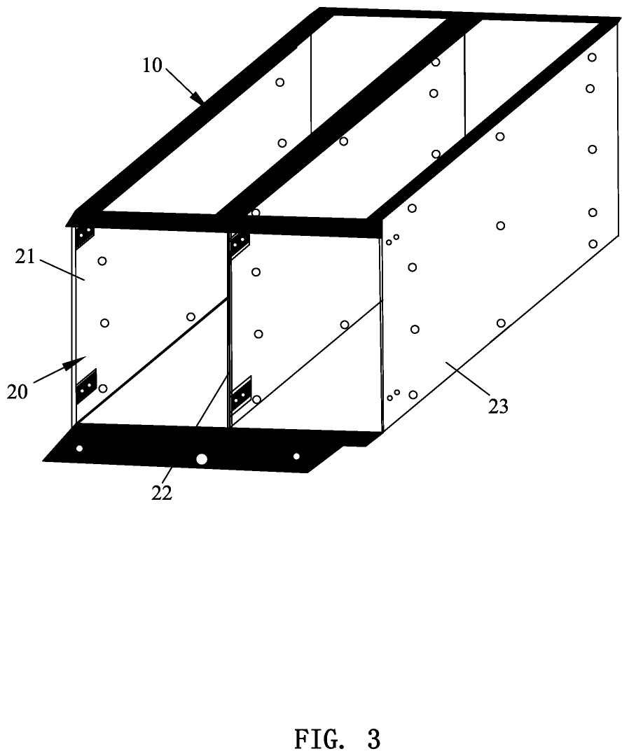

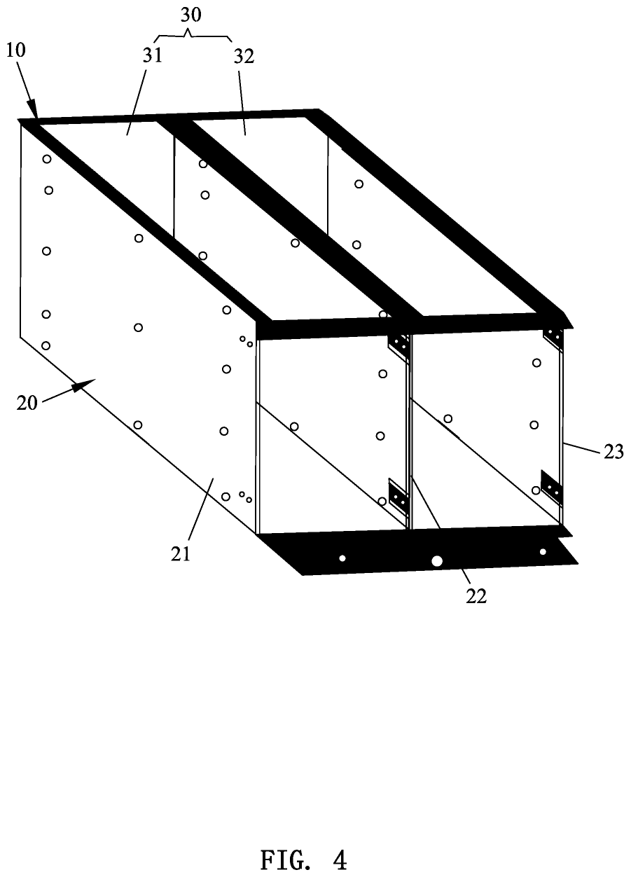

Referring to FIG. 3 and FIG. 4, the present invention discloses a heat generating device of a toaster, comprising a frame 10 and electric heating plates 20 mounted in the frame 10. A baking chamber 30 is formed between every adjacent two of the electric heating plates 20 for baking sliced bread. In use, the sliced bread is placed in the baking chamber 30, and the electric heating plates 20 are configured to generate heat for baking the bread. Wherein, the electric heating plates 20 may be plural. The more the number of the electric heating plates 20, the more the baking chambers 30 are formed, such that more sliced bread can be baked at one time.

In this embodiment, referring to FIG. 3 and FIG. 4, the number of the electric heating plates 20 is three, including a left electric heating plate 21, a middle electric heating plate 22, and a right electric heating plate 23. The two side electric heating plates are installed at the leftmost side and the rightmost side of the frame 10, respectively. The middle electric heating plate is disposed between the two side electric heating plates. A first baking chamber 31 is formed between the left electric heating plate 21 and the middle electric heating plate 22, and a second baking chamber 32 is formed between the right electric heating plate 23 and the middle electric heating plate 22. Each electric heating plate 20 includes a substrate and a heat-generating metal film A surface of the substrate of the left heating plate 21, facing the first baking chamber 31, is bonded with the heat-generating metal film A surface of the substrate of the right heating plate 23, facing the second baking chamber 32, is bonded with the heat-generating metal film Both front and back surfaces of the substrate of the middle heating plate 22 are bonded with the heat-generating metal film. In this way, it can be ensured that both sides of each baking chamber 30 have the heat-generating metal film, which can improve the baking efficiency of the sliced bread. The surface of the corresponding substrate, facing away from the baking chamber 30, doesn't have the heat-generating metal film to avoid unnecessary heating to cause energy loss.

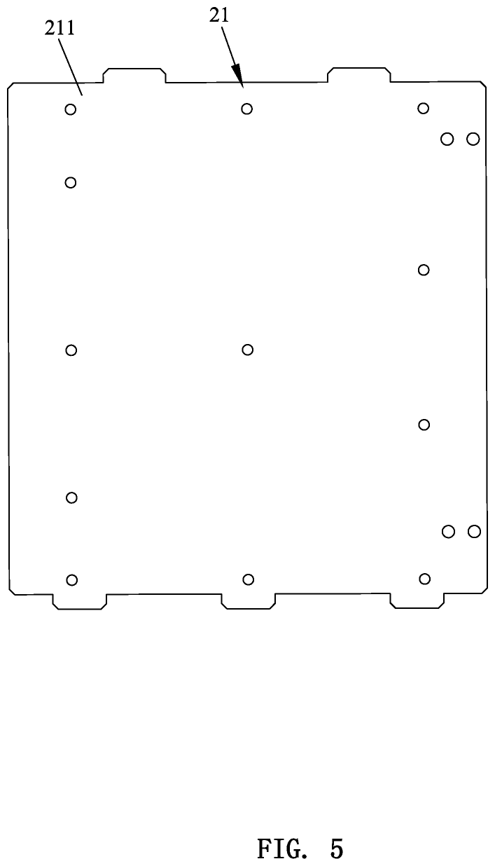

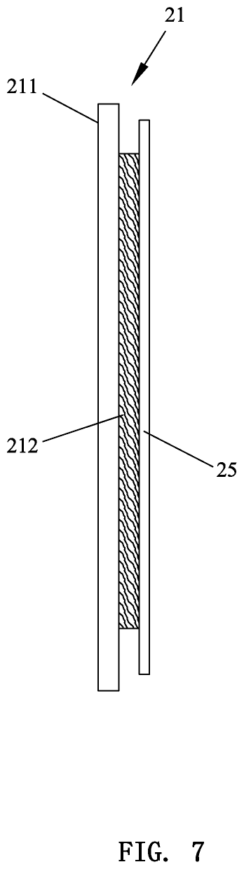

FIGS. 5 to 7 show a specific structure of the left electric heating plate 21. The left electric heating plate 21 includes a left substrate 211 and a left heat-generating metal film 212. The left heat-generating metal film 212 is bonded to the surface of the left substrate 211, facing the first baking chamber 31. That is, the back surface of the left substrate 211 doesn't have the heat-generating metal film, and only the front surface of the left substrate 211 is bonded with the heat-generating metal film.

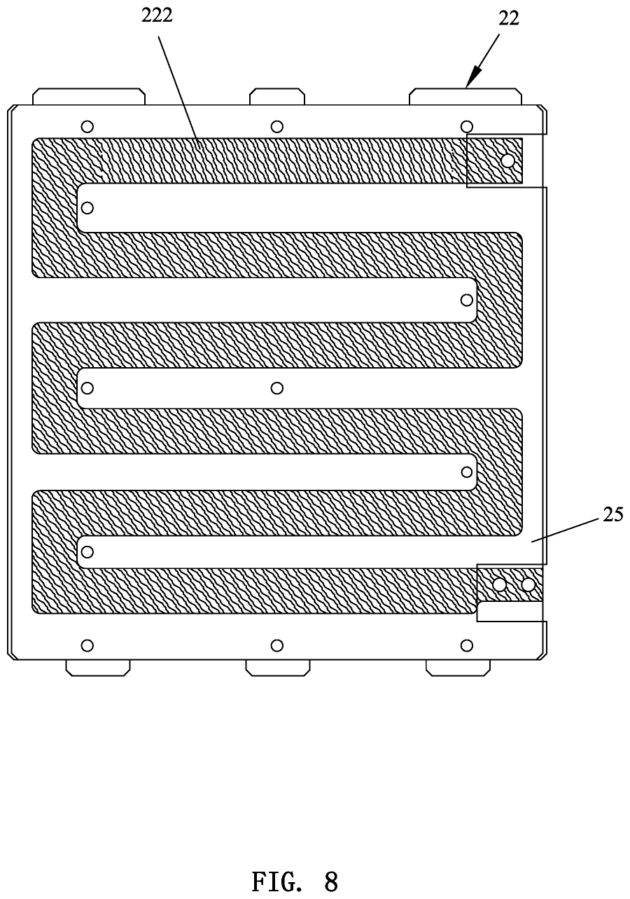

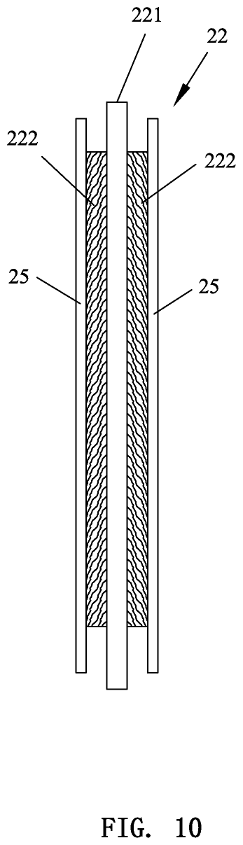

FIGS. 8 to 10 show a specific structure of the middle electric heating plate 22. The middle electric heating plate 22 includes a middle substrate 221 and two heat-generating metal films 222. The two middle heat-generating metal films 222 are bonded to both surfaces of the middle substrate 221, respectively, facing the first baking chamber 31 and the second baking chamber 32. That is, the front and back surfaces of the substrate of the middle substrate 221 have the heat-generating metal films.

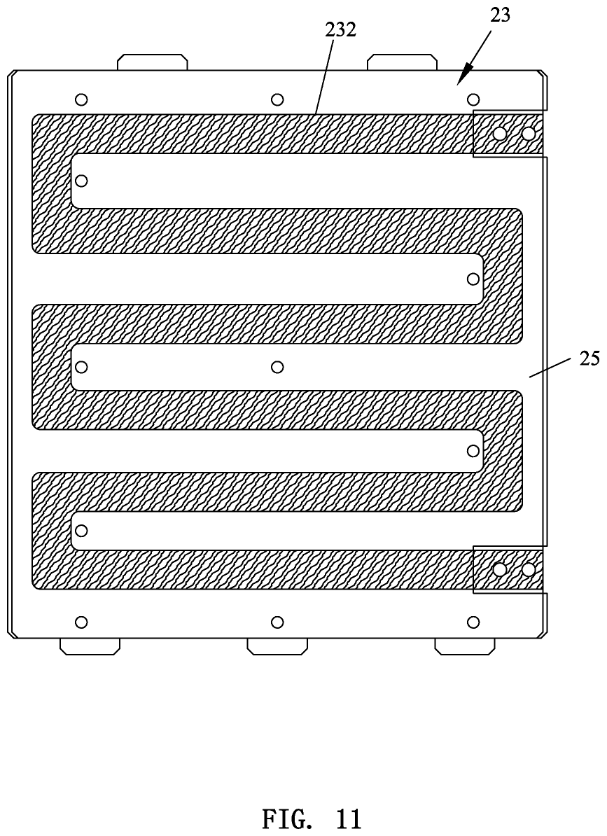

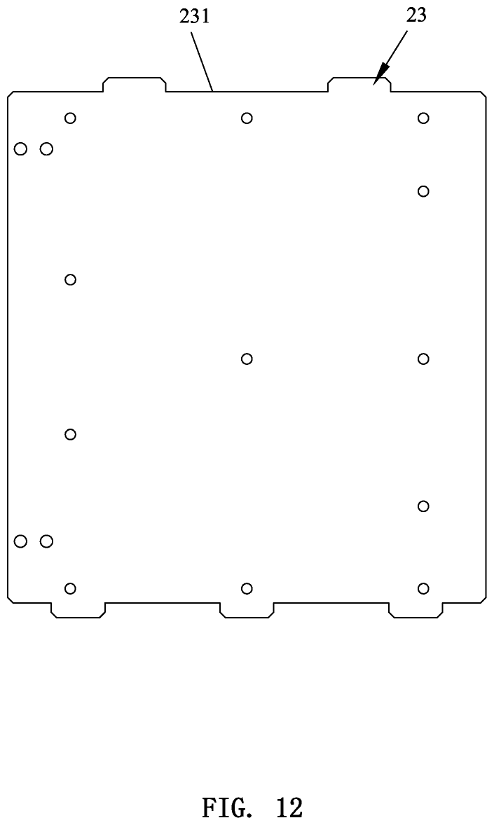

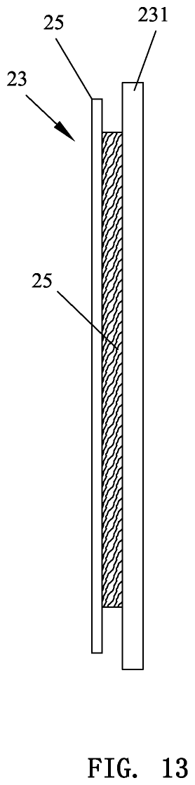

FIGS. 11 to 13 show a specific structure of the right electric heating plate 23. The right electric heating plate 23 includes a right substrate 231 and a right heat-generating metal film 232. The right heat-generating metal film 232 is bonded to the surface of the right substrate 231, facing the second baking chamber 32. That is, the back surface of the right substrate 231 doesn't have the heat-generating metal film, and only the front surface of the right substrate 231 is bonded with the heat-generating metal film.

In this embodiment, the substrate of each electric heating plate 20 is a mica plate. The mica plate is used as the substrate, which is a high-quality insulating material with the advantages of non-toxic, odorless, high-temperature resistance and good thermal conductivity, and is suitable for application in a toaster.

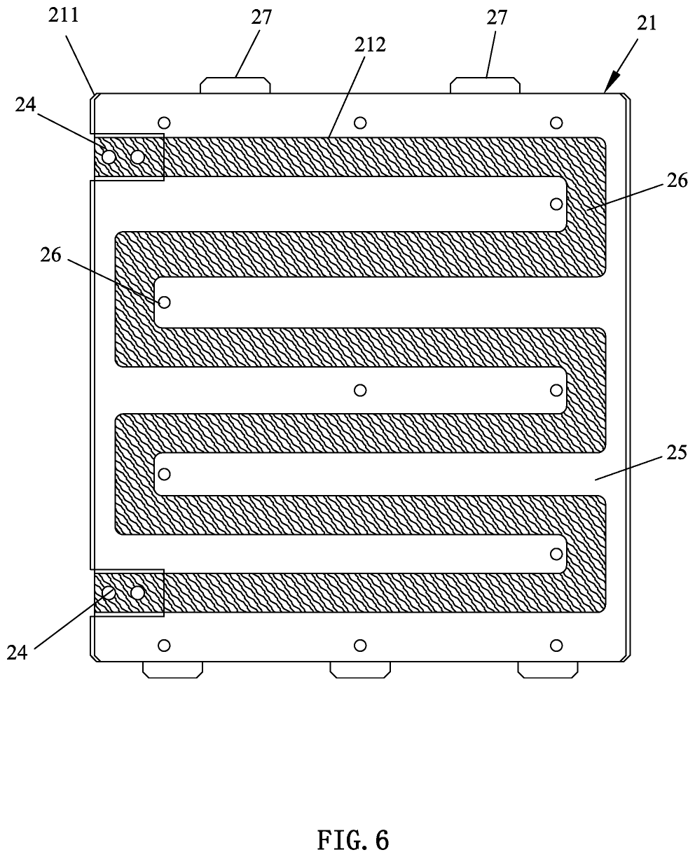

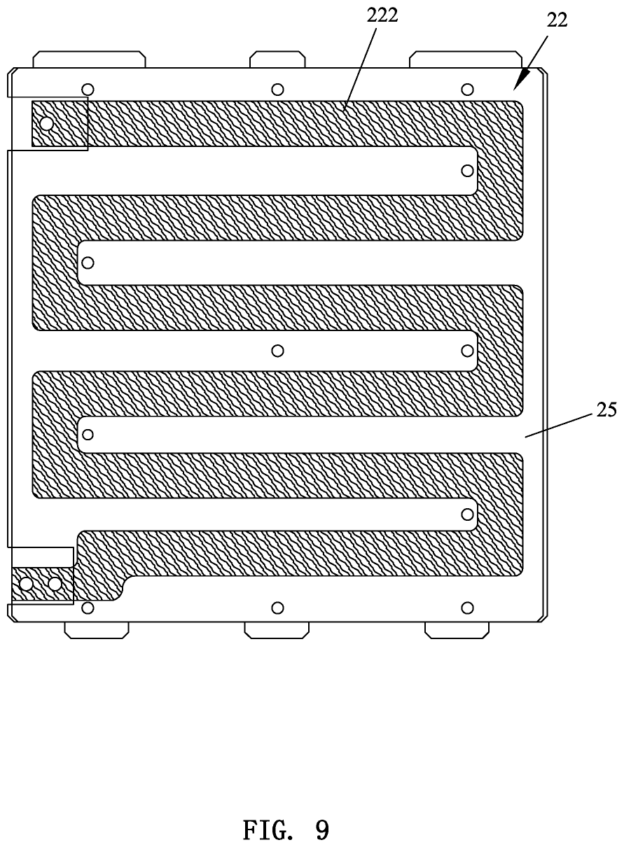

Referring to FIG. 6, FIG. 8, FIG. 9, and FIG. 11, the heating circuit of the heat-generating metal film in each electric heating plate 20 extends back and forth on the surface of the substrate to form a serpentine uniform structure, which can make heat generation uniform and stable in performance. It should also be noted that the length, the gap, and the thickness of the heating circuit can be freely designed according to the needs in practical applications. Moreover, the arrangement of the heating circuit is not limited to the appending drawings, and may be wound into other various shapes as needed.

The head end and the distal end of the heating circuit of the heat-generating metal film in each electric heating plate 20 are provided with power contacts 24. These power contacts 24 can be easily connected to realize the conduction of the heating circuit of the heat-generating metal film in the electric heating plate 20. When the material is selected, the heat-generating metal film is a resistive film and can generate heat after being energized.

In addition, a heat-conducting plate 25 may be covered on the surface of each heat-generating metal film. The heat-conducting plate 25 is connected to the substrate by a plurality of rivets 26, so that the heat-generating metal film is located between the substrate and the heat-conducting plate 25 to form a sandwich structure. On the one hand, the heat-generating metal film can be pressed by the heat-conducting plate 25 to prevent the heat-generating metal film from being detached from the substrate due to thermal expansion. On the other hand, the heat-conducting plate 25 makes the heat of the heat-generating metal film uniform. The sliced bread is baked evenly and tastes better. It won't burn parts of the sliced bread. In this embodiment, the heat-conducting plate 25 is a mica plate, and the thickness of the heat-conducting plate is less than the thickness of the substrate. In actual production, the thickness of the heat-conducting plate is preferably 0.1 mm to 0.2 mm The thin heat-conducting plate allows heat to be dissipated, and the thick substrate has a thermal insulation function. It should be noted that the heat-conducting plate 25 in the appending drawing is a partial structure. In order to arrange the heat-generating metal film better, the heat-conducting plate 25 is actually laid over the entire surface of the heat-generating metal film The upper end and the lower end of each electric heating plate 20 are provided with a plurality of protrusions 27 engaged with the frame 10. The shape and the number of the protrusions 27 may be adjusted according to actual needs.

The manufacturing process of the electric heating plate 20 of the present invention is as follows: selecting a mica plate as a substrate, bonding a whole piece of unpunched heat-generating metal film to the mica plate through an adhesive layer, and then removing parts of the heat-generating metal film by etching or engraving to form a heating circuit that extends back and forth. Finally, the heat-conducting plate 25 is placed on the surface of the heat-generating metal film, and a plurality of rivets 26 are used to fix the heat-conducting plate 25 and the substrate to form a sandwich structure of the heat-generating metal film The position of the rivet 26 should avoid the heating circuit.

When assembled, the middle electric heating plate 22 is installed in the middle of the frame 10 to divide the interior of the frame 10 into two. Then, the left electric heating plate 21 and the right electric heating plate 23 are mounted at the left and right sides of the frame 10, respectively. One surface of the left heating plate 21, having the heat-generating metal film, faces the first baking chamber 31. One surface of the right heating plate 23, having the heat-generating metal film, faces the second baking chamber 32. The left and right surfaces of the two baking chambers 30 have the heat-generating metal films to improve the baking efficiency of the sliced bread.

In use, the sliced bread is placed in the baking chamber 30, and the timing knob is rotated to start baking the sliced bread. Since the toaster in the example of the present invention has two baking chambers, two slices of bread can be baked at one time.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. A heat generating device of a toaster, comprising a frame, two side electric heating plates mounted at two sides of the frame, and a middle electric heating plate disposed between the two side electric heating plates; a baking chamber being formed between every adjacent two of the electric heating plates for baking sliced bread, characterized in that: each of the electric heating plates includes a substrate and a heat-generating metal film, a surface of the substrate of each of the two side electric heating plates, facing the baking chamber, is bonded with the heat-generating metal film, front and back surfaces of the substrate of the middle heating plate are bonded with the heat-generating metal film.

2. The heat generating device as claimed in claim 1, wherein the two side electric heating plates includes a left electric heating plate and a right electric heating plate respectively installed at a leftmost side and a rightmost side of the frame; a first baking chamber is formed between the left electric heating plate and the middle electric heating plate, a second baking chamber is formed between the right electric heating plate and the middle electric heating plate; a surface of the substrate of the left heating plate, facing the first baking chamber, is bonded with the heat-generating metal film; a surface of the substrate of the right heating plate, facing the second baking chamber, is bonded with the heat-generating metal film.

3. The heat generating device as claimed in claim 1, wherein the substrate of each of the electric heating plate is a mica plate.

4. The heat generating device as claimed in claim 1, wherein a heating circuit of the heat-generating metal film in each of the electric heating plates extends back and forth on the surface of the substrate to form a serpentine uniform structure.

5. The heat generating device as claimed in claim 4, wherein a head end and a distal end of the heating circuit of the heat-generating metal film in each of the electric heating plates are provided with power contacts.

6. The heat generating device as claimed in claim 1, wherein upper and lower ends of each of the electric heating plates are provided with a plurality of protrusions engaged with the frame.

7. The heat generating device as claimed in claim 1, wherein a surface of the heat-generating metal film is covered with a heat-conducting plate so that the heat-generating metal film is located between the substrate and the heat-conducting plate to form a sandwich structure.

8. The heat generating device as claimed in claim 7, wherein the heat-conducting plate is a mica plate.

9. The heat generating device as claimed in claim 7, wherein the heat-conducting plate has a thickness less that of the substrate.

10. The heat generating device as claimed in claim 7, wherein the heat-conducting plate has a thickness of 0.1 mm to 0.2 mm
